(19) United States
(12) Patent Application Publication
(10) Pub. No.: US 2015/0012931 A1
(43) Pub. Date: Jan. 8, 2015

(54) METHODS AND SYSTEMS ENABLING ACCESS BY PORTABLE WIRELESS HANDHELD DEVICES TO DATA ASSOCIATED WITH PROGRAMMING RENDERING ON FLAT PANEL DISPLAYS

(71) Applicants: Luis Miguel Ortiz, Albuquerque, NM (US); Luis M. Ortiz, Albuquerque, NM (US)

(72) Inventors: Luis Miguel Ortiz, Albuquerque, NM (US); Luis M. Ortiz, Albuquerque, NM (US)

(21) Appl. No.: 14/306,895

(22) Filed: Jun. 17, 2014

Related U.S. Application Data
(60) Provisional application No. 61/842,544, filed on Jul. 3, 2013.

(51) Int. Cl. H04N 21/41

(52) U.S. Cl. CPC H04N 21/4108; H04N 21/4126
USPC 725/25

(57) ABSTRACT

Flat panel displays (e.g., Smart TVs) can wirelessly broadcast their identity for discovery to users of handheld devices (e.g., smartphones) interested in obtaining additional data associated with programming displayed on the flat panel displays. Data can include video, text, audio, and identifying information needed to access related data from a remote server. An application can be downloaded and activated on smartphones that will enable them to see a list of available (discovered) flat panel displays (multiple screens, depending on venue) that allow wireless access to data associated with programming displayed (or previously displayed and stored in a queue) on flat panels. A flat panel of interest can be selected by the smartphone and it can access additional data (either directly from the flat panel or from a remote server once the data has been identified) and/or engage in an interactive session in association with the displayed programming or data.

### INVENTION PRIORITY

This application clams priority under 35 U.S.C. 119(e) to U.S. Provisional Patent Application Ser. No. 61/842,544, entitled “Methods and Systems Enabling Access by Portable Wireless Handheld Devices to Data Associated with Programming Rendering on Flat Panel Displays,” which was filed on Jul. 3, 2013, the disclosure of which is incorporated herein by reference in its entirety.

### FIELD OF THE INVENTION

The present invention is generally related to wireless handheld devices such as smartphones and also to fiat panel displays such as smart TVs., The present invention is also related to the exchange of data between devices. More particularly, the present invention is related to methods and systems enabling access to data associated with video programming rendering on flat panel displays by portable wireless handheld devices located near the flat panel displays.

### BACKGROUND

Television sets today can be connected to data networks (e.g., the Internet) and are being marketed as “Smart TVs” because of their data network accessing capabilities, as well as the smartphone-like user interfaces they provide. Smart televisions and smartphones have only recently been able to interact with what is being referred to as “second screen” applications; however, applications that are currently available are limited to the wireless rendering of data that is either provided from a smartphone onto the screen of a flat panel display utilizing small gateway and video streaming devices such those provided by Apple (e.g., Apple TV's Airplay) and Roku, or where data associated with programming displayed on the fiat panel display is accessed from a remote server (i.e., website) only alter identifying a program being watched on a large flat panel display to the server by name or access code. Media sharing to fiat panels directly from handhelds to fiat panels has also been enabled using other wireless means or standards such as DLNA via a router, and directly with flat panel devices using WIFI direct, which has recently been accomplished with applications such as Multiscreen Play (by Hisense), AllJoyn and Snapdragon (by Qualcomm), Content Share (by Haler), Miracast (by Panasonic), SmartShare (by LG), and others. Yet all of these applications are only described for use in sharing data in one direction—from handheld devices to larger flat panel devices.

To date, a flat panel display (Smart TV) is not known to provide data directly to smartphones following a request initiated at the smartphone. All data delivery today appears limited to what is provided from a handheld device (smartphone) to a large data network-enabled flat panel display (Smart TV), typically by utilizing the screen/data sharing technologies describe above. All current data exchange solutions are also limited to interaction between two devices, a smartphone and a flat panel display/smart TV that are already connected to each other and are wirelessly engaged to provide commands and data from the handheld device to the flat panel display or a smartphone and a remote server based on information obtained about a program being displayed on a flat panel display. There is currently no intermediary device or application that can identify information that is available for smartphone retrieval based on what is being displayed on flat panel displays.

An interesting data access problem presents itself in a scenario where there are several screens displaying multimedia data to spectators located in a public venue (e.g., a sports bar, sports stadium, casino sports book, etc.) rather than a private den or office. No solutions are currently available for spectators utilizing wireless handheld devices to access/select data associated with (or being rendered on) a screen chosen from several screens co-located at the venue whereon various multimedia content is also being displayed. The present inventors believe that spectators/observers at a public venue would like the ability to access specific content being displayed on and/or otherwise interact with what is being displayed on any of the multiple screens. This is especially true with respect to sports programming where fans often desire to access data associated with programming that will enable them to see a replay or review statistics.

### SUMMARY

It is therefore a feature of the present invention to enable smartphone device users to select a flat panel device to access data rendered thereon (currently or in the brief past) or engage in an interactive session associated with the data rendered on a selected flat panel device.

It is another feature of the present invention to enable flat panel devices to broadcast their identity via wireless communications (e.g., Bluetooth, or WiFi direct) to handheld devices utilizing an application that enables flat panel discovery and supports interaction with flat panels that are discovered and chosen by the handheld devices.

It is another feature of the present invention to enable portable handheld devices to wirelessly discover, select, and obtain data/associated information from a select flat panel display. The operational features of the portable handheld device can be enabled with an App that can be downloaded from a server.

What is needed is a way to easily select a large screen from among several co-located screens and access the content being displayed on the large screen in the venue so that user can view the data on their personal handheld devices as well as engage in an interactive session directly with the large screen or in association with the data displayed on the large screen. The present inventors believe it would also be desirable to access data that has already been displayed and is now past rendering by providing a data queue that can store the data, or identification information needed to retrieve the data, after the data has already been rendered on a large screen. With another feature of the present invention, past data can be retrieved from a remote server over a data network based on the identification information, or directly from large screen with on-board memory capable of storing a limited amount of multimedia data previously displayed on the large screen.

In accordance with features of the preset invention, flat panel displays are enabled to wirelessly broadcast their identity for discovery and also data associated with the content being displayed to multiple users of handheld devices (e.g., smartphones). This capability can be referred to as mediacasting, or Mediacast-enabled with respect to aspects of the mediacasting capability directly incorporated into flat panel devices. Data can include video, text, audio, and identifying information needed to access such data from a remote server. Handheld device users can activate an application on their smartphones that will enable them to see a list of available (discover) flat panel displays (often multiple screens, depending on venue) that allow wireless access by handheld devices to data being displayed (or previously displayed and stored in a queue) on the flat panel displays. The smartphone users can select the screen of interest (or data for the screen of interest) and access additional data (either directly from the flat panel or from a remote server once the data has been identified) and/or engage in an interactive session in association with the displayed data.

In accordance with additional features of the present invention, possible venues that can deploy the mediacasting concept disclosed herein are: sports bars, sports venues, educational institutions, casino sports books, shopping centers, amusement parks, and the like.

In accordance with yet another features, an application (“APP”) that enables smartphones to interact with Mediacast-enabled flat panels can be downloaded from application providers (e.g., Apple, Google Android, etc.).

Wireless standards that can be used to implement the invention include Bluetooth and WiFi direct.

Tablets and laptops could also be used to access data under the teaching described herein.

### BRIEF DESCRIPTION OF THE FIGURES

FIG. 1 illustrates a system enabling flat panel discovery and access to data associated with programming displayed on a flat panel selected by a handheld device;

FIG. 2 illustrates a system enabling flat panel discovery and access to data associated with programming displayed on a particular flat panel selected by a handheld device when several flat panel devices are also located near the handheld device;

FIG. 3 illustrates a system deployed in a large venue such as a sports stadium that utilizes wireless infrastructure at the venue to broadcast available data associated with programming being displayed on flat panel displays located throughout the large venue and can also enable access to the data associated with programming displayed on a particular flat panel (e.g., flat panels deployed in a private suite location) selected by a handheld device when several flat panel devices are also located near the handheld device in accordance with features of the present invention;

FIG. 4 illustrates a screen shot from a handheld device illustrating a list of flat panels wirelessly discovered for access to data therefrom;

FIG. 5 illustrates a screen shot form a handheld device illustrating a list of programming accessible from a queue (memory) associated with a flat panel selected by the handheld device;

FIG. 6 illustrates a block diagram of steps for discovering a flat panel with a handheld device and accessing data associated with programming displayed on the flat panel; and

FIG. 7 illustrates a block diagram of steps enabling discovery of a flat panel device by handheld devices and for providing data associated with programming displayed on the flat panel to handheld devices.

### DETAILED DESCRIPTION OF THE INVENTION

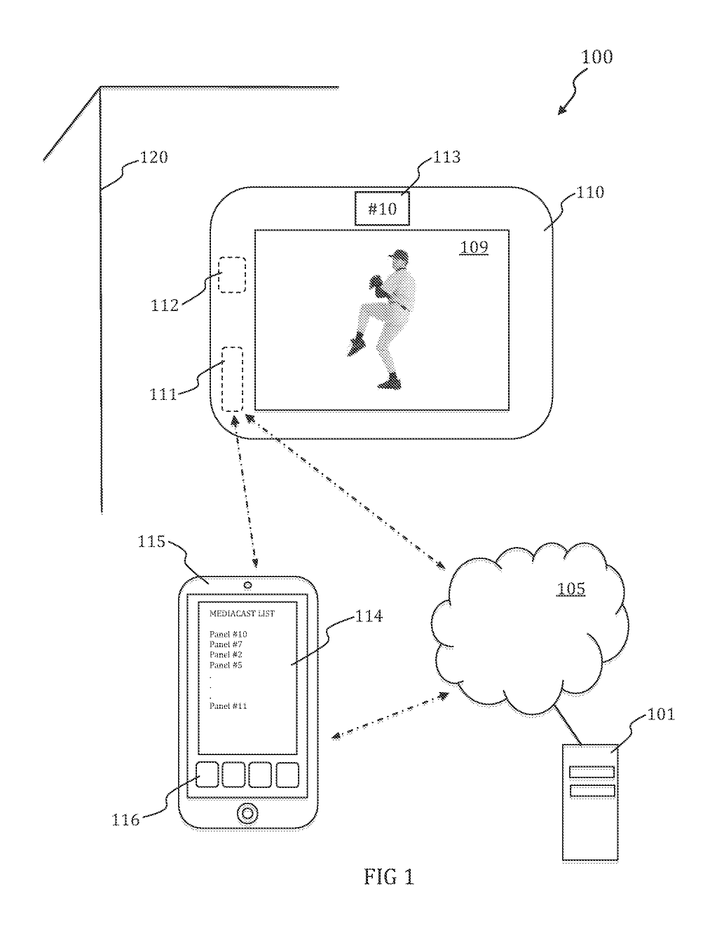

FIG. 1 illustrates a system 100 enabling flat panel discovery and access to data associated with programming displayed on a flat panel 110 selected by a handheld device 115. A flat panel 110 can have access to a data network 105 to retrieve programming and information from a remote server 101. The flat panel 110 can also have an internal wireless communication module 111 (e.g., WiFi or Bluetooth, or both) to support communications with nearby handheld devices 115 or to obtain further data access from the network 105. The flat panel device can include a memory 112 that can function as a queue to store programming displayed on a display screen (e.g., LCD, LED, Plasma, or the like) integrated in the flat panel, and which can include a limited amount of past programming previously displayed on the display screen 109 integrated in the flat panel. The wireless communication module can wirelessly broadcast identifying information 113 for the flat panel 101 to nearby handheld devices 115. The identifying information 113 can be an identification number (label #10, as shown) physically located on or near a flat panel 110 that can be read by spectators, electronic information broadcasted about the physical location of the flat panel 110 in a venue 120, and broadcasted information about programming being displayed on the flat panel 110. The broadcast of wireless-enabled device identities is common for WiFi hotspots and Bluetooth connected devices, where identifying information is periodically sent for receipt by devices in search of a wireless data connection; however, flat panel television sets do not broadcast identifying information (in particular, after market labels, or physical location information), and information broadcasted from other devices today are not used for purposes of obtaining data associated with programming displayed on flat panel displays where numerous other flat panel displays may also be co-located (located next to each other) in a crowded venue (e.g., a sports bar, casino or sports stadium).

Flat panels 110 enabled with a wireless communication module 111 can be programmed using a mediacasting application to broadcast identifying information rather than just the manufacturer and model information. Manufacturer and model information would be useless if broadcasted from ten flat panel devices in a sports bar that are made by the same manufacturer and are the same model. This is why the use of unique identifying information is necessary in accordance with features of the present invention. Information will be described in further detail below, but can include physical location, programming information or a name/label physically attached to the flat panel to assist users in identification of the desired flat panel to interact with.

The handheld device 115 can be provided in the form of a smartphone (e.g., iPhone, Android-based smartphone) and include an application 116 that enables the discovery of available flat panels 110 near the handheld device 115. Discovery can be accomplished by receiving identifying information 113 for the flat panel in a list of available devices 114. The flat panel 110 can be selected on the handheld device 115, and the handheld device 115 can then begin receiving data associated with programming displayed at the flat panel 110. The handheld device 115 can also interact with programming displayed at the flat panel 110 via the application 116.

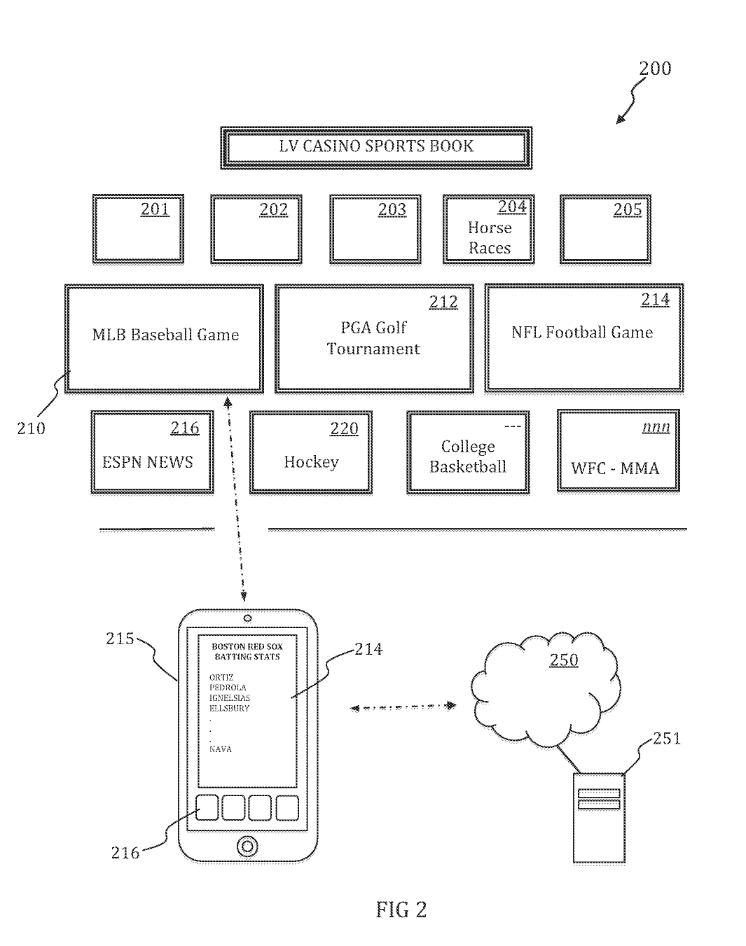

FIG. 2 illustrates a system 200 enabling a particular flat panel's discovery and access to data associated with programming displayed on a particular flat panel 210 selected by a handheld device 215 when several flat panel devices 201, 212, 216, nnn are also located near the handheld device 215 and the flat panel 210 of interest. Such a scenario would be common in a publicly accessible venue, such as a sports bar or casino sports book where multiple flat panel displays rendering various programming are available. In this type of scenario, a Mediacast application 216 can be opened on the handheld device 215 that will enable the handheld device 215 to locate the flat panel 210 of interest from among several flat panels that are also broadcasting their identities.

Identities can be determined numerically and based on content. Numerical identification can first be physical (e.g., by a user reading a number marked on the housing of a flat panel) and then electronic, based on information obtained physically. Identification can also be based on physical location information (e.g., “60 inch Sony-above cash register-over bar”), Identification can also be based on programming (e.g., “LA Lakers”, “Dodgers” or “HDTV”). It is entirely possible that the same programming of interest will be displayed on multiple flat panels located at the same venue. It this case, any of the flat panels 212 displaying the same programming of interest can be selected for data retrieval by and/or interaction with the handheld device 215. Once common programming information of interest is identified (i.e., the same football game, regardless of the flat panel used to identify it, the handheld device 215 can retrieve programming related data from either the selected flat panel and a remote server 251 via a wireless data network.

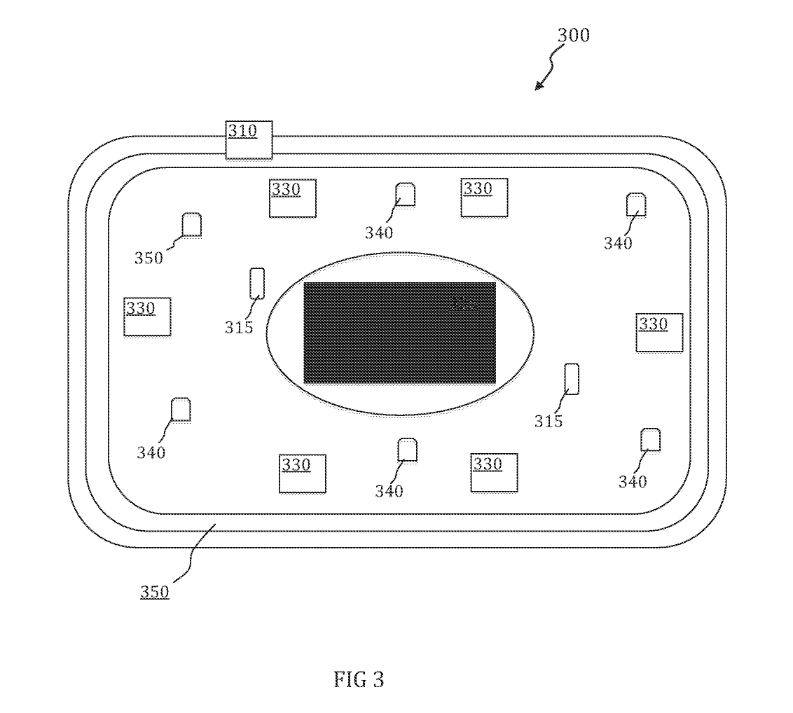

FIG. 3 illustrates a system 300 deployed in a large venue 350 such as a sports stadium that utilizes wireless infrastructure including hotspots 340 at the venue to broadcast available data associated with programming being displayed on flat panel displays 330 located throughout common areas of the large venue to handheld devices 315 also located at the venue 350, and can also enable access to the data associated with programming displayed on a particular flat panel 310 (e.g., flat panels deployed in a private suite location) selected by handheld devices 315 when several flat panel devices are also located near the handheld device in accordance with features of the present invention. Wireless infrastructure can include hotspots deployed throughout the large venue. U.S. Pat. No. 8,320,820 issued to Ortiz, co-inventor of the present invention, entitled “Self-contained data communication system nodes as stand-alone pods or embedded in concrete walkways and in walls at public venues including sports and entertainment venues” describes hotspots deployed in a sports venue to enable handheld device access to venue-related data. U.S. Pat. No. 8,320,820, which can be utilized to implement certain novel features of the present invention, is hereby incorporated by reference in its entirety for its teaching. The hotspot pods described by Ortiz can be adapted with mediacasting capabilities as described herein to provide handheld devices users with a list of data related to programming being displayed on flat panels in the venue that is available for retrieval by the handheld devices, or the availability of interaction with the programming that is being displayed. With the present invention, the skilled can imagine a multi participant interactive session (e.g., gaming, social networking) that is directly associated with programming being displayed on flat panels located at the venue.

In accordance with features of the present invention, a system deployed in a sports stadium 350 can enable sports fans using smartphones 315 to interact with media being displayed at the venue to retrieve instant replays, statistics, and other data based on programming being viewed on numerous flat panel displays 330 typically located within such a venue 350. A football fan, for example, can re-watch an instant replay for a programming he just viewed on a flat panel display 310 located near his seat, a baseball fan can review additional facts statistics for an athlete shown on a flat panel 310 that is currently at bat. The invention benefits all sports (basketball, soccer, ice hockey, tennis) so long as flat panel displays 330 exist in the venue and are displaying active programming to attendees. Programming information can be used by the handheld device 315 to retrieve additional information from a remote server as previously described.

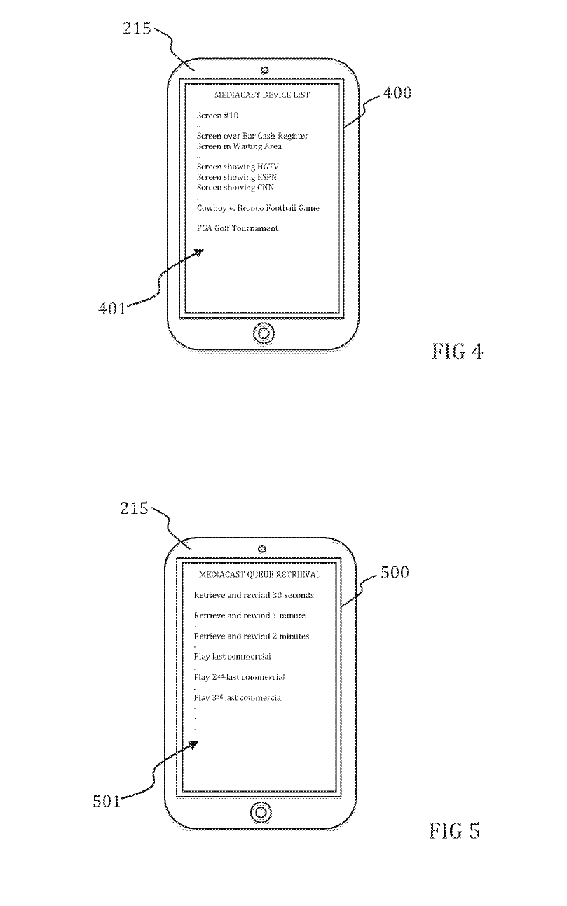

FIG. 4 illustrates a screen shot 400 from a handheld device 215 illustrating a menu-like list 401 of flat panels that were wirelessly discovered by the handheld device 215 for access to data therefrom. A handheld device user can select a flat panel from a list based on the handheld device user's programming of interest. Once selected, the handheld device 215 will be engaged in a data retrieval and/or interaction session. Data can be retrieved based on real-time programming that is being displayed on a flat panel, or for programming that was recently displayed but has now passed (e.g., a commercial that has already passed, an instant replay of a live sports game, or statistical information about an athlete). Referring to FIG. 5, a screen shot 500 is shown from a handheld device 215 that can provide a list of past programming 501 accessible from a queue (memory) associated with a selected flat panel that can still be selected and data retrieved by the handheld device. This aspect of the invention is of high value in sports media where fast moving games can cause a sports fan to miss an important play or statistical information about an athlete or team that has already passed the screen. A user can be provided with limited access to past programming from a queue associated with the flat panel device, however, a menu of past programming as described with respect to FIG. 5 will simplify access to desired information by users. The listing can be provided in the form of time (e.g., “rewind 30 seconds”, “rewind 1 minute”, “rewind 2 minutes”) or based on identifying information (e.g., “last commercial”, “2^{nd}-last commercial”, “3^{rd} last commercial”). Alternatively, the content can be displayed as recorded video with a scroll bar that can include “pause”, “play”, “forward”, and “rewind” capabilities, similar to that provided for reviewing Youtube videos. The display of stored video content previously displayed by the flat panel and stored in the queue can also be enhanced with image tiles that pop up as the user moves along the scroll bar to help the user focus in on images for the video location that the user wants to review from the queue. Once the proper content is identified, the user can access data associated with the past programming/content.

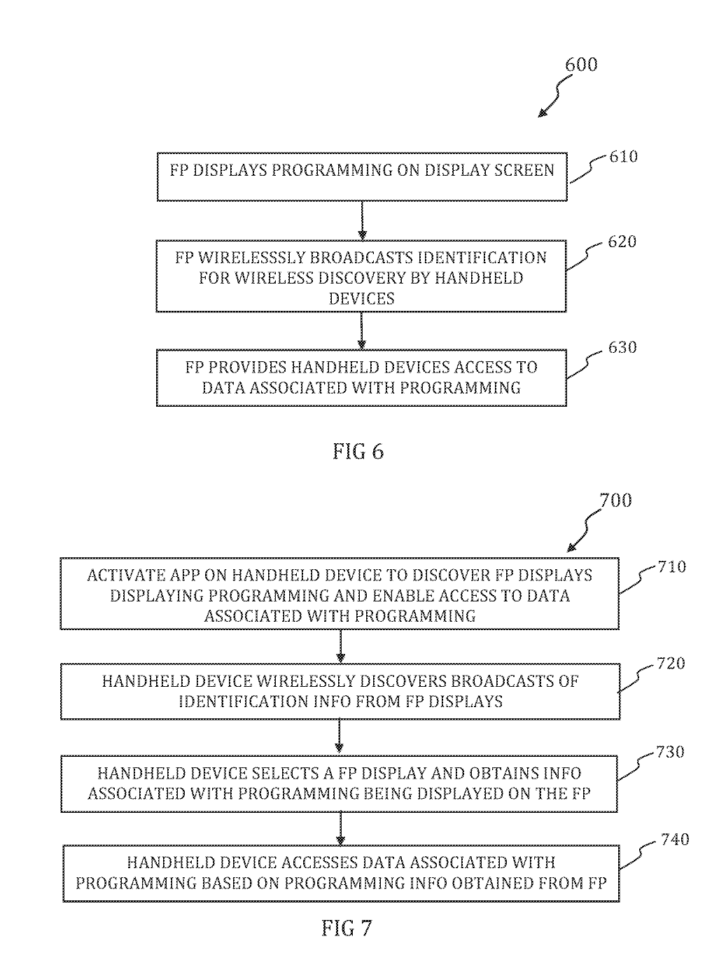

FIG. 6 illustrates a block diagram 600 of steps for discovering a flat panel with a handheld device and accessing data associated with programming displayed on the flat panel. As shown in block 610, a flat panel displays programming on a display screen integrated in a flat panel display. In block 620, the flat panel wirelessly broadcasts its identification for wireless discovery by handheld devices. Then, at block 630 the flat panel provides the handheld devices access to data associated with the programming.

FIG. 7 illustrates a block diagram 700 of steps enabling discovery of a flat panel device by handheld devices and for providing data associated with programming displayed on the flat panel to handheld devices. As shown in block 710, an application (Mediacast application) is activated on a handheld device to discover flat panel displays that are displaying programming on a display screen integrated in a flat panel display and enabling access to data associated with the programming. The handheld device then wirelessly discovers broadcasts of identification information from the flat panel displays as shown in block 720. The handheld device is then used to select a flat panel display and obtains information associated with programming being displayed on the flat panel as shown in block 730. The information can include data (e.g., video, replay, etc.), but the handheld device can use information obtained from the flat panel to then access additional data associated with the programming being displayed on the selected flat panel display as shown in block 740.

It should be appreciated from the foregoing disclosure that the methods and systems described herein can be utilized in various environments including private offices or living rooms and public venues such as sports bars, casinos, sports stadiums, shopping centers, amusement parks, transportation terminals, educational institutions, and others.

1. A method enabling access to data associated with programming rendering on flat panel displays by handheld devices located near the flat panel displays, comprising:
displaying programming on a display screen integrated in a flat panel display;
wirelessly broadcasting an identification of the flat panel display for wireless discovery by handheld devices; and
providing the handheld devices access to data associated with the programming.

2. The method enabling access to data associated with programming rendering on flat panel displays by handheld devices located near the flat panel displays of claim 1, wherein said wirelessly broadcasting an identification of the flat panel display for wireless discovery by handheld devices occurs using Bluetooth network communications.

3. The method enabling access to data associated with programming rendering on flat panel displays by handheld devices located near the flat panel displays of claim 1, wherein said wirelessly broadcasting an identification of the flat panel display for wireless discovery by handheld devices occurs using WiFi network communications.

4. The method enabling access to data associated with programming rendering on flat panel displays by handheld devices located near the flat panel displays of claim 1, wherein access to data associated with the programming is provided to handheld devices from a server over a data communications network.

5. The method enabling access to data associated with programming rendering on flat panel displays by handheld devices located near the flat panel displays of claim 1, wherein access to data associated with the programming is provided to handheld devices from a flat panel display.

6. The method enabling access to data associated with programming rendering on flat panel displays by handheld devices located near the flat panel displays of claim 2, wherein access to data associated with the programming is provided to handheld devices from a server over a data communications network.

7. The method enabling access to data associated with programming rendering on flat panel displays by handheld devices located near the flat panel displays of claim 2, wherein access to data associated with the programming is provided to handheld devices from a flat panel display.

8. The method enabling access to data associated with programming rendering on flat panel displays by handheld devices located near the flat panel displays of claim 4, wherein said wirelessly broadcasting an identification of the flat panel display for wireless discovery by handheld devices occurs using at least one of Bluetooth and WiFi network communications.

9. The method enabling access to data associated with programming rendering on flat panel displays by handheld devices located near the flat panel displays of claim 1, further comprising the step of supporting an interactive session between said handheld devices and flat panel displays in association with the data associated with the programming.

10. The method enabling access to data associated with programming rendering on flat panel displays by handheld devices located near the flat panel displays of claim 9, wherein said interactive session between said handheld devices and flat panel displays in association with the data associated with the programming is supported over at least one of Bluetooth and WiFi communications.

11. A method enabling access to data associated with programming rendering on flat panel displays by handheld devices located near the flat panel displays, comprising:
activating an application on a handheld device to discover flat panel displays that are displaying programming on a display screen integrated in a flat panel display and enabling access to data associated with the programming;
wirelessly discovering broadcasts of identification information for the flat panel displays;
selecting a flat panel display and obtaining programming information therefrom; and
accessing data associated with the programming being displayed on the selected flat panel display.

12. The method enabling access to data associated with programming rendering on flat panel displays by handheld devices located near the flat panel displays of claim 11, wherein said step of accessing data associated with the programming being displayed on the selected flat panel display occurs using at least one of Bluetooth and WiFi network communications.

13. The method enabling access to data associated with programming rendering on flat panel displays by handheld devices located near the flat panel displays of claim 11, wherein said step of wirelessly discovering broadcasts of identification information for the flat panel displays occurs using at least one of Bluetooth and WiFi network communications.

14. The method enabling access to data associated with programming rendering on flat panel displays by handheld devices located near the flat panel displays of claim 13, wherein said step of accessing data associated with the programming being displayed on the selected flat panel display occurs using at least one of Bluetooth and WiFi network communications.

15. The method enabling access to data associated with programming rendering on flat panel displays by handheld devices located near the flat panel displays of claim 12, wherein said step of wirelessly discovering broadcasts of identification information for the flat panel displays occurs using at least one of Bluetooth and WiFi network communications.

16. The method enabling access to data associated with programming rendering on flat panel displays by handheld devices located near the flat panel displays of claim 11, further comprising the step of supporting an interactive session between said handheld devices and flat panel displays in association with the data associated with the programming.

17. The method enabling access to data associated with programming rendering on flat panel displays by handheld devices located near the flat panel displays of claim 16, wherein said interactive session between said handheld devices and flat panel displays in association with the data associated with the programming is supported over at least one of Bluetooth and WiFi communications.

18. A flat panel display, comprising:
access to a data network;
at least one wireless data communications module;
flat panel identification information; and
a memory containing displayed programming;
wherein said wireless data communication module broadcasts flat panel identification information and data associated with programming to handheld devices requesting the data and the data is obtained from at least one of said memory or a remote server via the data network.

19. The flat panel display of claim 18, wherein said at least one wireless data communications module includes at least one of a Bluetooth and WiFi network communications transceiver providing said handheld devices access to data associated with the programming being displayed on the selected flat panel display.

20. The flat panel display of claim 18, wherein said at least one wireless data communications module includes at least one of a Bluetooth and WiFi network communications transceiver providing said handheld devices access to said flat panel identification information.
